(19) United States
(12) Patent Application Publication
(10) Pub. No.: US 2019/0225762 A1
(43) Pub. Date: Jul. 25, 2019

(54) QUARTZ GLASS FIBER-CONTAINING PREPREG, QUARTZ GLASS FIBER-CONTAINING FILM AND QUARTZ GLASS FIBER-CONTAINING SUBSTRATE

(71) Applicant: SHIN-ETSU CHEMICAL CO., LTD., Tokyo (JP)

(72) Inventors: Yoshihiro TSUTSUMI, Annaka-shi (JP); Yoshihira HAMAMOTO, Takasaki-shi (JP); Toshio SHIOBARA, Annaka-shi (JP); Akihiko OSAKI, Annaka-shi (JP)

(73) Assignee: SHIN-ETSU CHEMICAL CO., LTD., Tokyo (JP)

(21) Appl. No.: 16/237,815

(22) Filed: Jan. 2, 2019

(30) Foreign Application Priority Data
Jan. 19, 2018 (JP) 2018-007529
Jan. 19, 2018 (JP) 2018-007545
Jan. 19, 2018 (JP) 2018-007642

(51) Int. Cl. C08J 5/08; C08J 5/18; C08K 3/36; C03C 25/47

(52) U.S. Cl. CPC C08J 5/08; C08J 5/18; C08J 2363/04; C03C 25/47; C08K 3/36

(57) ABSTRACT

The present invention is a quartz glass fiber-containing prepreg including: (A) a quartz glass fiber; and (B) a curable resin composition, wherein at least one condition of conditions: (1) a dose of α-ray contained in the quartz glass fiber is 0.005 c/cm²·hour or smaller, and, each of metal ion contents of Na⁺, Li⁺ and K⁺ is 1 ppm or lower; (2) the quartz glass fiber contains the number of foams of 10 foams/m² or smaller a unit area; and (3) the quartz glass fiber-containing prepreg has the common bending stiffness in the range of a thickness of 100 to 200 μm measured by a method described in JIS R 3420:2013 of 500 N·m² or larger is satisfied. This provides a quartz glass fiber-containing prepreg that has particularly excellent dielectric characteristics, has excellent dielectric characteristics and the heat resistance, and/or has high handling property because of high bending stiffness characteristics.

### TECHNICAL FIELD

The present invention relates to a quartz glass fiber-containing prepreg, a quartz glass fiber-containing film and a quartz glass fiber-containing substrate.

### BACKGROUND ART

With the development of the digital technology, reduction in weight, thickness and length of electronic devices typical in personal computers and portable telephones have been advanced, and high-density mounting and reduction in weight, thickness, and length are demanded on, for example, printed circuit boards that are a typical product. In order to respond to this, there is a strong demand for characteristics improvement on a glass fiber-containing prepreg, a glass fiber-containing substrate and a film.

Furthermore, with higher speed and higher frequency of computers, mobiles, communication infrastructures, and the like, low dielectric substrates or films excellent in the transmission loss as characteristics demanded on printed circuit boards are demanded (PATENT LITERATURE 1). Furthermore, high tensile stiffness characteristics and uniformity and thinning of glass fibers are demanded for low dielectric materials and ultrathin substrates or films excellent in the transmission loss (PATENT LITERATUREs 1, 6).

So far, as glass cloths used in the substrates or films, cloths woven from an E glass fiber or a D glass fiber have been used (see PATENT LITERATUREs 2 to 4). Although a natural quartz glass fiber having particularly small dielectric constant and dielectric loss has gathered attention among glass fibers, there are disadvantages such that the natural quartz glass fiber is expensive, very hard relative to normal glass fibers, and has a defect such that boring or polishing processes of via holes of a multilayered substrate is very difficult (PATENT LITERATURE 5).

Furthermore, so far, as glass cloths used in the prepregs or substrates, cloths woven from an E glass fiber or D a glass fiber have been used (see PATENT LITERATUREs 2 to 4). Among the glass fibers, particularly from characteristics such as high heat resistance, low impurity, low dielectric constant, dielectric loss, and the like, the quartz glass fiber gathers attention.

Furthermore, since a general glass cloth contains hollow fibers containing foams, a plating liquid, a washing liquid, an etching liquid, or the like used in a substrate forming step intrudes into the foams present in the cloth to result in generation of conduction failure due to lack of a plating layer and generation of degradation of the dielectric characteristics. On the other hand, since the quartz glass cloth has a small content of hollow fibers, the conduction failure or degradation of the dielectric characteristics that are problematic in the general glass cloth does not occur.

### CITATION LIST

### Patent Literature

Patent Document 1: JP 2016-131243 A

Patent Document 2: JP H09-74255 A

Patent Document 3: JP H02-61131 A

Patent Document 4: JP S62-169495 A

Patent Document 5: JP 2004-99377 A

Patent Document 6: JP 2015-155196 A

### SUMMARY OF THE INVENTION

### Technical Problem

The present invention was carried out in view of the above situations and intends to provide a quartz glass fiber-containing prepreg, and a quartz glass fiber-containing film and a quartz glass fiber-containing substrate in which the quartz glass fiber-containing prepreg is used, which are excellent in semiconductor applications, in particular, in dielectric characteristics, since a dose of radiation of alpha-ray is very small, and impurity elements are very small such that a content of each of alkali metal ions Na⁺, Li⁺ and K⁺ is 1 ppm or lower, which are excellent in dielectric characteristics and the heat resistance, and/or which have high handling property and furthermore excellent dielectric characteristics, since the strength and bending stiffness characteristics are high.

### Solution to Problem

To achieve the above object, the present invention provides a quartz glass fiber-containing prepreg comprising:

(A) a quartz glass fiber; and
(B) a curable resin composition,
wherein at least one condition of conditions (1) to (3):
(1) a dose of α-ray contained in the (A) quartz glass fiber is 0.005 c/cm²·hour or smaller, and, each of metal ion contents of Na⁺, Li⁺ and K⁺ is 1 ppm or lower;
(2) the (A) quartz glass fiber contains the number of foams of 10 foams/m² or smaller a unit area; and
(3) the quartz glass fiber-containing prepreg has the common bending stiffness in the range of a thickness of 100 to 200 μm measured by a method described in JIS R 3420:2013 of 500 N·m² or larger is satisfied.

In the quartz glass fiber-containing prepreg like this, by satisfying the condition of the (1), a quartz glass fiber-containing prepreg, a quartz glass fiber-containing film and a quartz glass fiber-containing substrate which are excellent in semiconductor applications, in particular, in dielectric characteristics are obtained.

Furthermore, by satisfying the condition of the (2), when the quartz glass fiber containing a slight amount of foams is used, a quartz glass fiber-containing prepreg excellent in the dielectric characteristics and heat resistance is obtained.

Still furthermore, by satisfying the condition of the (3), since the strength and bending stiffness characteristics are high, high handling property and excellent dielectric characteristics are obtained.

Furthermore, it is preferable that a fiber diameter of the (A) quartz glass fiber is 3 μm or larger and 9 μm or smaller, and a fictive temperature is 1,300° C. to 1500° C.

When the fiber diameter and the fictive temperature are like this, a substrate having a uniform thickness may be formed and becomes the most suitable material for an ultrathin substrate or film. Furthermore, quartz glass fiber-containing prepreg excellent in processability and mass productivity, and excellent in structural stability is obtained.

Furthermore, it is preferable that the (B) curable resin composition contains at least one kind of curable resin among a thermosetting resin and/or a photosetting resin selected from a silicone resin, a curable polyimide resin, a maleimide resin, an epoxy resin, a cyanate resin, and a (meth)acrylic resin.

When containing the curable resin like this, ones excellent in the processability, the heat resistance, and electric characteristics are obtained.

Furthermore, it is preferable that the (B) curable resin composition further contains an inorganic filler.

When containing the inorganic filler like this, low thermal expansion characteristics, high elastic modulus, heat resistance and fire retardancy of the curable resin composition may be improved.

Furthermore, the present invention provides a quartz glass fiber-containing film characterized by comprising a cured material of one sheet of the quartz glass fiber-containing prepreg.

By using the quartz glass fiber-containing prepreg of the present invention, the quartz glass fiber-containing film like this may be prepared.

Furthermore, in this case, it is preferable that an absolute value of a difference between a dielectric tangent at 1.0 GHz and a dielectric tangent at 10 GHz is 0 or larger and 0.01 or smaller.

In the case of the quartz glass fiber-containing film like this, a material suitable for applications to various electronic components is obtained.

Furthermore, the present invention provides a quartz glass fiber-containing substrate characterized by comprising: a laminate cured material of two or more sheets of the quartz glass fiber-containing prepregs.

By using the quartz glass fiber-containing prepreg of the present invention, the quartz glass fiber-containing substrate like this may be prepared.

Furthermore, in this case, it is preferable that an absolute value of a difference between a dielectric tangent at 1.0 GHz and a dielectric tangent at 10 GHz is 0 or larger and 0.01 or smaller.

In the case of the quartz glass fiber-containing substrate like this, a material suitable for applications to various kinds of electronic components is obtained.

### Advantageous Effects of Invention

As was described above, in the case of the quartz glass fiber-containing prepreg of the present invention, by satisfying the condition of the (1), a quartz glass fiber-containing prepreg, film and substrate that are excellent in semiconductor applications, in particular, in dielectric characteristics, since a dose of radiation of alpha-ray is very small, and impurity elements are very small such that a content of alkali metal ions Na⁺, Li⁺ and K⁺ is 1 ppm or lower may be provided. Furthermore, since filament diameters are uniform, a material that is excellent in surface uniformity, may form a substrate having a uniform thickness, and is most suitable for an ultrathin substrate or film may be provided.

Furthermore, in the case of the quartz glass fiber-containing prepreg of the present invention, by satisfying the condition of the (2), a quartz glass fiber-containing prepreg that is excellent in the dielectric characteristics, has high strength and high tensile stiffness characteristics, and is excellent in surface uniformity, thin-film formability and plating property is formed, and may be suitably used in the quartz glass fiber-containing film and quartz glass fiber-containing substrate.

Furthermore, in the case of the quartz glass fiber-containing prepreg of the present invention, by satisfying the condition of the (3), since the strength and bending stiffness characteristics are high, the handling property is high and the dielectric characteristics becomes excellent.

### DESCRIPTION OF EMBODIMENTS

The present invention is a quartz glass fiber-containing prepreg and includes:

(A) a quartz glass fiber; and
(B) a curable resin composition, wherein at least one condition of conditions (1) to (3):
(1) a dose of α-ray contained in the (A) quartz glass fiber is 0.005 c/cm²·hour or smaller, and, each of metal ion contents of Na⁺, Li⁺ and K⁺ is 1 ppm or lower;
(2) the (A) quartz glass fiber contains the number of foams of 10 foams/m² or smaller a unit area; and
(3) the quartz glass fiber-containing prepreg has the common bending stiffness in the range of a thickness of 100 to 200 μm measured by a method described in JIS R 3420:2013 of 500 N·m² or larger is satisfied.

In what follows, the present invention will be described in detail. However, the present invention is not limited to these.

In what follows, a quartz glass fiber-containing prepreg of the present invention will be more detailed.

### [(A) Quartz Glass Fiber]

Although a quartz glass fiber in the present invention may be fiber-like or cloth-like called a glass cloth, from the reason that handling is easy or the like, a quartz glass cloth is preferably used. The quartz glass cloth is prepared with, for example, a quartz glass strand and/or a quartz glass yarn. The quartz glass strand and/or the quartz glass yarn is formed by bundling 50 or more and 500 or smaller of the quartz glass fibers. By the way, in the present invention, one obtained by bundling without twisting is called a strand, and one obtained by bundling with twisting is called a yarn.

The fictive temperature of the quartz glass fiber is preferably in the range of 1,300 to 1,500° C., and in the range of the fictive temperature, the processability and mass productivity are excellent and the structural stability is excellent. The fiber diameter of the quartz glass fiber is preferably 3 μm or larger and 9 μm or smaller.

Since three kinds of alkali metal elements of Na, K and Li contained in the quartz glass fiber are cationized and have a large effect on the dielectric characteristics because of high diffusion coefficients. Therefore, the quartz glass fiber-containing prepreg of the present invention makes to be 1 ppm or smaller each of these metal ions a part of the condition (1). The content of each of the metal ions is preferably 0.5 ppm or smaller.

Also other element contents, it is preferable that a sum total of contents of two kinds of alkaline earth metal elements of Ca and Mg is 0.5 ppm or smaller, a sum total of contents of Cu and Ag is 0.2 ppm or smaller, a sum total of contents of Fe, Ni and Cr is 1 ppm or smaller, and a content of Al is 1 ppm or smaller.

Furthermore, the quartz glass fiber-containing prepreg makes that a dose of α-ray contained in the (A) quartz glass fiber is 0.005 c/cm²·hr or smaller a part of the condition (1). The dose of α-ray is preferably 0.003 c/cm²·hr or smaller. In the case of this dose or lower, in the case of using for an electronic component such as a substrate, an adverse effect is preferably difficult to reach the element.

Furthermore, the quartz glass fiber-containing prepreg of the present invention sets that the quartz glass fiber contained in the quartz glass fiber-containing prepreg of the present invention has a very small content of foams such that the number of foams is 10 foams/m² or smaller a unit area the condition (2). The number of the foams is preferably 5 foams/m² or lower.

The quartz glass fiber contained in the quartz glass fiber-containing prepreg of the present invention preferably has characteristics such as high heat resistance, lower impurity contents, low dielectric constant, low dielectric loss, and the like, in addition to the above characteristics. Furthermore, it is preferable to have high strength and high tensile stiffness characteristics, surface uniformity and thin film formability.

As the quartz glass fiber, a quartz glass fiber that has natural quartz glass and/or synthetic quartz glass as a raw material may be used. However, in order to reduce contents of the impurity elements, the synthetic quartz glass is preferable.

### [(B) Curable Resin Composition]

As the (B) curable resin composition, one in which the following components are mixed may be used.

### <Curable Resin>

The curable resin is preferable to be a thermosetting resin and/or a photosetting resin and may be in any state of liquid, semisolid and solid at an ordinary temperature (25° C.). Specifically, a silicone resin, a curable polyimide resin, a maleimide resin, an epoxy resin, a cyanate resin, a (meth)acrylic resin, and the like may be used, and the (B) curable resin composition used in the quartz glass fiber-containing prepreg, substrate and film of the present invention preferably contain at least one of the curable resin selected therefrom. Among these, the silicone resin, curable polyimide resin, maleimide resin, and epoxy resin are preferably used. By the way, the curable resins may be used singularly or in a combination of a plurality of resins.

### <<Silicone Resin>>

As the silicone resin, an addition-curable silicone resin and a condensation-type silicone resin may be used. As the addition-curable resin, a silicone resin containing, for example, (a) to (c) components shown below is used.

(a) An organopolysiloxane represented by the following average composition formula (1) and has at least two or more alkenyl groups bonded to a silicon atom in one molecule,

(R¹₃S i O_{1/2})ₐ(R¹₂S i O_{2/2})_{b}(R¹S i O_{3/2})_{c}(S i O_{4/2})_{d} (1)

wherein, R² is independently a group selected from a hydroxyl group, aliphatic hydrocarbon groups having 1 to 10 carbons, alicyclic hydrocarbon groups having 5 to 10 carbons, aromatic hydrocarbon groups having 6 to 10 carbons, and alkenyl groups having 2 to 10 carbons, and “a”, “b”, “c”, and “d” are the numbers satisfying respectively a≥0, b≥0, c≥0, d≥0 and a+b+c+d=1, (b) an organohydrogenpolysiloxane represented by the following average composition formula (2) and has at least two or more hydrogen atoms bonded to a silicon atom in one molecule,

(R²₃S i O_{1/2})ₑ(R²₂S i O_{2/2})_{f}(R²S i O_{3/2})_{g}(S i O_{4/2})ₕ (2)

wherein, R² is independently a group selected from a hydrogen atom or hydroxyl group, aliphatic hydrocarbon groups having 1 to 10 carbons, alicyclic hydrocarbon groups having 5 to 10 carbons, and aromatic hydrocarbon groups having 6 to 10 carbons, and “e”, “f”, “g”, and “h” are the numbers respectively satisfying e≥0, f≥0, g≥0, h≥0 and e+f+g+h=1.
(A compounding ratio of the (a) component and (b) component is an amount such that an amount of hydrogen atoms bonded to the silicon atom in the (b) component is 0.1 to 5.0 mol to one mol of the alkenyl groups bonded to the silicon atom in the (a) component), and
(c) an addition reaction catalyst.

Furthermore, as the condensation-type silicone resin, a silicone resin containing the following (d) component is used.

(d) An organopolysiloxane represented by the following average composition formula (3) and has at least two or more condensation reaction groups in one molecule is used,

(R³₃S i O_{1/2})ᵢ(R³₂S i O_{2/2})ⱼ(R³S i O_{3/2})ₖ(S i O_{4/2})ₗ (3)

wherein, R³ is independently a group selected from a hydroxyl group, alkoxy groups having 1 to 6 carbons, aliphatic hydrocarbon groups having 1 to 10 carbons, alicyclic hydrocarbon groups having 5 to 10 carbons, and aromatic hydrocarbon groups having 6 to 10 carbons, and at least two or more of R^{a}s in one molecule are groups selected from hydroxyl groups or alkoxy groups having 1 to 6 carbons, and “i”, “j”, “k”, and “l” are the numbers respectively satisfying i≥0, j≥0, k≥0, l≥0 and i+j+k+l=1.

The (d) alone is condensed and cured by heating. However, in order to accelerate curing, a condensation catalyst may be separately added.

The silicone resin contains 10 mol % to 99 mol %, preferably 15 mol % to 80 mol %, more preferably 17 mol % to 75 mol % of aryl groups bonded to silicon atoms relative to an entire organic groups bonded to silicon atoms.

### <<Curable Polyimide Resin, Maleimide Resin>>

The curable polyimide resin is categorized according to chemical properties of its reactive terminal group. Among these, the maleimide resin is preferably used from the viewpoint of processability or handling property. In what follows, the maleimide resin will be described.

The maleimide resin is a compound having two or more maleimide groups in one molecule, and may be a resin that is cured by reaction of maleimide groups by heating. As the maleimide resin, although N,N′-(4, 4′-diphenyl methane)bismaleimide and bis(3-ethyl-5-methyl-4-maleimidephenyl)methane are cited, among these, a maleimide resin having an aliphatic hydrocarbon group in a main chain is preferable because it is excellent not only in the heat resistance but also in the dielectric characteristics.

Furthermore, in order to more accelerate curing, a reaction initiator may be contained. Although the reaction initiator is not limited, peroxides, and the like may be used. Furthermore, a compound having a functional group that can react with a maleimide group may be contained as a curing agent. Examples of the curing agent include alicyclic maleimides, aromatic maleimides, unsaturated hydrocarbon, aromatic amines, aliphatic amines, alicyclic amines, acid anhydrides, isocyanates, and the like.

### <<Epoxy Resin>>

An epoxy resin may contain two or more epoxy groups in one molecule. Examples thereof include: bisphenol A type epoxy resin, bisphenol F type epoxy resin, bisphenol S type epoxy resin, alicyclic epoxy resin, aliphatic chain epoxy resin, phenol novolak type epoxy resin, cresol novolak epoxy resin, bisphenol A novolak type epoxy resin, phenol aralkyl type epoxy resin, naphthol novolak type epoxy resin, naphthalene skeleton-containing type epoxy resins such as naphthol aralkyl type epoxy resin and the like, bifunctional biphenyl type epoxy resin, biphenyl aralkyl type epoxy resin, dicyclopentadiene type epoxy resin, dihydroanthracene type epoxy resin, and the like. Among these, from the viewpoints of dielectric characteristics and thermal expansion characteristics, the naphthalene skeleton-containing type epoxy resin or biphenyl aralkyl type epoxy resin are preferably used. These may be used singularly or in a combination of two or more kinds thereof.

Furthermore, a curing agent that reacts with the epoxy resin may be used, and the kind thereof is not particularly limited. Examples thereof include phenol-based curing agents, acid anhydrate-based curing agents, amine-based curing agents, furthermore, a benzoxazine compound. These curing agents may be used singularly or in a combination of two or more kinds thereof. As a compounding ratio of the epoxy resin and the curing agent, relative to 1.0 equivalent of active groups reactive with epoxy groups of the curing agent, epoxy groups in the epoxy resin are compounded at a ratio of 0.5 to 2.0 equivalents, preferably 0.6 to 1.8, and more preferably 0.8 to 1.5. At this ratio, a substrate or a film that is excellent in the characteristics such as a glass transition temperature after curing and has high reliability is formed.

Furthermore, in order to enhance the reactivity of the epoxy resin and the curing agent, a curing promoter may be added. As the curing promoter, without particular limitation, examples thereof include nitrogen-based curing agents such as amines and imidazole, and phosphate-based curing promotors such as quaternary phosphonium salts, furthermore organometallic salts and derivatives thereof.

### <<Cyanate Resin>>

As the cyanate resin, if it contains two or more cyanate groups in one molecule, there is no particular limitation. However, for example, ones obtained in such a manner that a halogenated cyan compound and phenols or naphthols are reacted, followed by, as needs arise, a method of heating to form a prepolymer may be used.

Examples of the cyanate resins include novolak type cyanate resins, bisphenol type cyanate resins, naphthol aralkyl type cyanate resins, dicyclopentadiene type cyanate resins, biphenyl alkyl type cyanate resins, and the like. Among these, one has a small cyanate equivalent may obtain a cured material having small curing shrinkage, low thermal expansion coefficient, and high glass transition temperature. These may be used singularly or in a combination of two or more kinds thereof.

A curing agent or a curing catalyst may be further contained. The kind of the curing agent or the curing catalyst is not particularly restricted, and as the curing agent, phenol-based curing agents, a dihydroxy naphthalene compound, and the like may be used, and as the curing promoter, primary amines and metal complexes may be used.

### (Meth) Acrylic Resin>>

Examples of the (meth)acrylic resins include polymers and copolymers such as (meth)acrylic acid, (meth)acrylonitrile, (meth) acrylic acid ester, (meth)acryl amide, and the like. However, when a resin contains a (meth)acryl skeleton, it is not limited to resins cured by a reactive group such as an acryloyl group, a methacryloyl group, or the like.

Furthermore, in order to adjust the curability, a radical polymerization initiator or a photopolymerization initiator such as a peroxide, or a curing promoter that promotes a reaction of a reactive group that the (meth)acryl resin has may be added. These resins may be used singularly or in a combination of two or more kinds among the respective resin groups. Furthermore, two or more kinds of the resins selected from the respective resin groups may be used together. In particular, a mixed composition of the maleimide resin (compound) of (B-2) and the cyanate resin (compound) of (B-4) is known as a BT resin and has excellent processability, heat resistance, electric characteristics, and the like.

### <Inorganic Filler>

The (B) curable resin composition preferably further contains an inorganic filler. When an appropriate inorganic filler is optionally contained, low thermal expansion characteristics, high elastic characteristics, heat resistance and flame retardancy of the cured resin composition may be improved.

As the inorganic filler, ones usually compounded in the thermosetting resin composition such as the epoxy resin composition and the like may be used. Without particular restriction, examples thereof include silica, silica converted into cristobalite, alumina, titanium dioxide, mica, beryllia, barium titanate, potassium titanate, strontium titanate, calcium titanate, aluminum carbonate, magnesium hydroxide, aluminum hydroxide, aluminum silicate, calcium carbonate, calcium silicate, magnesium silicate, silicon nitride, boron nitride, sintered clay, talc, aluminum borate, silicon carbide, and the like. Among these, in order to obtain low thermal expansion coefficient, silica is preferably compounded, and in order to obtain particularly high packing, spherical silica is preferably compounded. These may be used singularly or in a combination of two or more kinds thereof.

A shape and a particle size of the inorganic filler are not particularly limited. The shape of the inorganic filler may be, for example, spherical or in a crushed state, however, as was described above, the spherical shape is preferable to obtain high filling. A particle diameter of the inorganic filler may be set to, for example, 0.01 to 50 μm, preferably 0.01 to 20 μm, more preferably 0.1 to 15 μm, and more preferably 0.1 to 10 μm. Here, the particle size indicates an average particle size, and may be set to a value obtained as a mass average value D₅₀ (or a median diameter) in a particle size distribution measurement by a laser light diffraction method.

A compounding ratio of the inorganic filler to the curable resin is not particularly limited. However, from the viewpoints of adhesiveness, toughness, heat resistance, and chemical resistance of the cured resin, the range of 1 to 1,000 pts·mass is preferable relative to 100 pts·mass of a total amount of the curable resin component, and from the viewpoint of maintaining the toughness after curing while suppressing the thermal expansion of the curable resin, 100 to 800 pts·mass is more preferable.

### <Other Additives>

As needs arise, not only the curing agent/curing promotor, but also various kinds of additives such as an adhesive aid, a silane coupling agent, a titanate coupling agent, a thermoplastic resin, a pigment, resin particle, and the like may be compounded. By the way, as the additives, known additives may be used.

### <<Adhesive Aid>>

In order to impart adhesiveness to the (B) curable resin composition, an adhesive aid (adhesiveness-imparting agent) may be added. As the adhesive aid, for example, silanes and siloxanes that contain, in one molecule, a hydrogen atom bonded to a silicon atom (Si—H group), an alkenyl group bonded to a silicon atom (for example, Si—CH═CH₂ group), an alkoxysilyl group (for example, trimethoxysilyl group), an epoxy group (for example, glycidoxypropyl group, 3,4-epoxycyclohexylethyl group), an isocyanate group (for example, organooxysilyl-modified isocyanurate compound and its hydrolysis condensate), or the like as a functional group may be used. By the way, the adhesive aids may be used singularly or in a combination of two or more kinds thereof.

### <<Coupling Agent>>

In order to enhance the bonding strength of the (A) quartz glass fiber and the (B) curable resin composition or in order to enhance the wettability of the curable resin composition to the quartz glass fiber, coupling agents such as a silane coupling agent, a titanate coupling agent, or the like may be added. Furthermore, a quartz glass fiber of which surface is treated with a coupling agent in advance may be used.

Examples of the coupling agent include: gamma-glycidoxypropyltrimethoxysilane, gamma-glycidoxypropylmethyldiethoxysilane, epoxy-functional alkoxy silanes such as beta-(3,4-epoxycyclohexyl)ethyltrimethoxysilane, and the like; aminofunctional alkoxy silanes such as N-beta-(aminoethyl)-gamma-aminopropylmethoxysilane, gamma-aminopropyltriethoxysilane, N-phenyl-gamma-aminopropyltrimethoxysilane, and the like; silane coupling agents such as mercaptofunctional alkoxy silanes such as gamma-mercaptopropyltrimethoxysilane and the like; and titanate-coupling agents such as isopropyl triisostearoyl titanate, tetraoctylbis(ditridecylphosphite)titanate, bis(dioctylpyrophosphate)oxyacetate titanate, and the like. By the way, a compounding amount and a surface treatment method of the coupling agents used in the surface treatment are not particularly limited.

### <<Thermoplastic Resin>>

Furthermore, in order to improve the characteristics, as a dielectric characteristics improvement agent and a stress reliever, a thermoplastic resin may be added. Examples of the thermoplastic resin include fluororesins, polyphenylene ether resins, styrene-ethylene-butylene copolymers, cycloolefin polymers, acryl block copolymers, and the like. An optional amount thereof may be added.

### <<Pigment, Dye>>

In order to color, a pigment or a dye may be added. Examples of the pigment include inorganic pigments such as carbon black, titanium black, kaolin, synthetic red iron oxide, nickel titanium yellow, hydrous chromium oxide, chromium oxide, cobalt aluminate, synthetic ultramarine blue, and the like. Examples of the dye include isoindolinone, isoindoline, quinophthaline, xanthene, diketopyrrolopyrrole, perylene, perinone, anthraquinone, indigoid, oxazine, quinacridone, benzimidazolone, violanthrone, phthalocyanine, azomethine, and the like. These may be added at an optional amount.

The quartz glass fiber-containing prepreg of the present invention sets that common bending stiffness in the range of a thickness of 100 to 200 μm measured according to a method described in JIS R 3420:2013 is 500 N·m² or larger as the above condition (3). The common bending stiffness is preferably 1,000 is N·m² or larger.

The quartz glass fiber-containing prepreg of the present invention contains the quartz glass fiber and the curable resin composition and may satisfy at least one condition of the (1) to (3) conditions. By the way, it is preferable to satisfy two of conditions of the (1) to the (3), and more preferable to satisfy all.

### [Production Method of Quartz Glass Fiber-Containing Prepreg, Film and Substrate]

A production method of the quartz glass fiber-containing prepreg of the present invention is not particularly limited. A general production method of the quartz glass fiber-containing prepreg or the like may be applied. For example, a coating method of the curable resin to general glass fibers may be used to produce.

As the coating method, for example, coating machines such as a direct gravure coater, a chamber doctor coater, an offset gravure coater, a single roll kiss coater, a reverse kiss coater, a bar coater, a reverse roll coater, a slotter die, an air doctor coater, a normal roll coater, a blade coater, a knife coater, a dip coater, an MB coater, an MB reverse coater, and the like may be used.

In order to improve and secure the coating property, the (B) curable resin composition may be diluted with a solvent. From the dissolution characteristics of the curable resin, organic solvents may be used singularly or by mixing two kinds or more thereof. Examples of the organic solvent include: alcohols such as methanol, ethanol, isopropanol, n-butanol, and the like; ketones such as acetone, methyl ethyl ketone, methyl isobutyl ketone, and the like; glycol ethers such as ethylene glycol, propylene glycol, and the like; aliphatic hydrocarbons such as hexane, heptane, and the like; aromatic hydrocarbons such as toluene, xylene, and the like; and ethers such as diethyl ether, diisopropyl ether, di-n-butyl ether, and the like.

Though the condition is different depending on the curable resin composition used, for example, after coating on the quartz glass fiber according to the above method, by drying at 25 to 150° C., preferably 50 to 120° C. to render a B stage, a quartz glass fiber-containing prepreg may be obtained. When the obtained prepreg is cured by heating at 25 to 300° C. for 1 minute to 24 hours, a quartz glass fiber-containing film or a quartz glass fiber-containing substrate may be obtained. By the way, in the present invention, one obtained by curing by heating one sheet of the prepreg is called a quartz glass fiber-containing film, and one obtained by curing by heating two or more sheets of the prepreg is called a quartz glass fiber-containing substrate.

By the way, when preparing the substrate, simultaneously with the heating, the pressure forming may be applied. In this case, it is preferable to mold by applying pressure of 5 to 50 MPa with a hydraulic press or a vacuum press. The quartz glass fiber-containing substrate and quartz fiber-containing film of the present invention have excellent dielectric characteristics. Specifically, an absolute value of a difference of a dielectric tangent at 1.0 GHz and a dielectric tangent at 10 GHz is preferably 0 or larger and 0.01 or smaller. Within this range, a material suitable for applications to various kinds of electronic components that utilize the low dielectric characteristics is obtained.

The quartz glass fiber-containing prepreg of the present invention satisfies the condition of the (1), so that the quartz glass-containing film and substrate produced like this have very small dose of radiation of alpha-ray, and alkali metal element contents of Na, Li and K of 1 ppm or lower, and very low contents of other impurity elements. Therefore, a quartz glass fiber-containing film and substrate that are excellent in the transmission loss and dielectric characteristics that are required on printed circuit boards and the like accompanying semiconductor applications, in particular, accompanying higher speed/higher frequency of computers, mobiles, and communication infrastructures are obtained. Furthermore, since filament diameters are uniform, a substrate having excellent surface uniformity and uniform thickness may be molded, and an ultrathin substrate or film may be obtained.

Furthermore, the quartz glass fiber-containing prepreg of the present invention satisfies the condition of the (2), so that the quartz glass fiber-containing film and substrate produced like this have very small content of foams in a quartz glass fiber used. Therefore, there is no fear that a plating liquid, a washing liquid, an etching liquid, or the like used in a substrate molding step intrude into foams present in a quartz glass cloth that constitutes the substrate or film to damage a plating layer. Therefore, quartz glass fiber-containing film and substrate free from defects such as generation of conduction failure or degradation of the dielectric characteristics are obtained. Furthermore, high strength, high tensile stiffness characteristics, surface uniformity and thin film formability are excellent.

Furthermore, the quartz glass fiber-containing prepreg of the present invention satisfies the condition of the (3), so that the quartz glass fiber-containing film and substrate of the present invention are prepared by using the prepreg having common bending stiffness of 500 N·m² or larger. Therefore a film and a substrate having excellent flexibility are obtained.

Furthermore, the quartz glass fiber-containing film and substrate of the present invention have high strength and high tensile stiffness characteristics and excellent surface uniformity and thin film formability.

The substrate and film of the present invention, which are mainly made of the quartz glass fiber, have very low impurity element contents. Therefore, the quartz glass fiber-containing substrate and film that are excellent in the transmission loss and dielectric characteristics that are required on printed circuit boards accompanying semiconductor applications, in particular, accompanying higher speed/higher frequency of computers, mobiles, and communication infrastructures are obtained.

### EXAMPLES

In what follows, the present invention will be specifically described with reference to Examples and Comparative Examples. However, the present invention is not limited to these.

### Examples 1 to 2, Comparative Examples 1 to 7

### Preparation of Quartz Glass Fiber

With glasses shown in Table 1 below, glass cloths that have a thickness of 0.1 mm and are used in Examples 1 to 2 and Comparative Examples 1 to 7 were prepared. Kinds, doses of alpha-ray and each ion content of Na, Li, and K are also described in Table 1. By the way, quartz glass cloths of Comparative Examples 6 and 7 were prepared by adding an ion part during preparation of the quartz glass cloth of Example 1.

TABLE 1

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | Unit | Example 1 | Example 2 | Example 1 | Example 2 | Example 3 | Example 4 | Example 5 | Example 6 | Example 7 |
| Kind of | | Quartz | Quartz | E-glass | T-glass | C-glass | S-glass | D-glass | Quartz | Quartz |
| glass | | glass | glass | | | | | | glass | glass |
| cloth | | | | | | | | | | |
| Alpha | c/cm² · hr | 0.001 | 0.0001 | 0.012 | 0.007 | 0.051 | 0.020 | 0.010 | 0.009 | 0.009 |
| dose | | | | | | | | | | |
| Na⁺ | ppm | 0.8 | <0.01 | 12.0 | 2.2 | 18.0 | 12.9 | 9.5 | 2.5 | 2.5 |
| K⁺ | ppm | 0.7 | <0.01 | 3.5 | 1.1 | 6.0 | 3.8 | 4.0 | 1.9 | 0.7 |
| Li⁺ | ppm | 0.4 | <0.01 | 3.2 | 1.1 | 4.6 | 3.1 | 2.9 | 0.4 | 2.0 |

### Preparation of Curable Resin Composition

A slurry of a filler-containing epoxy resin composition made of 10 pts·mass of a cresol novolak type epoxy resin (product name: EPICLON N-695, manufactured by DIC), 5 pts·mass of a phenol novolak resin (product name: PEHNOLITE TD-2090, manufactured by DIC), 0.1 pt·mass of an imidazole-based curing accelerator (product name: 2E4MZ, manufactured by SHIKOKU CHEMICALS CORPORATION), 85 pts·mass of spherical silica (product name: SC-2050-SE, manufactured by ADMATECHS) and 50 pts·mass of a MEK solvent was prepared.

### Preparation of Quartz Glass Fiber-Containing Prepreg and Film

Each of glass cloths shown in Table 1 was soaked in the filler-containing epoxy resin composition slurry, followed by drying at 100° C. for 10 minutes to prepare a prepreg, further followed by curing the prepreg at 180° C. for 4 hours, thus a glass cloth-containing film was prepared. By the way, an adhesion amount of the resin was 55 mass % for all.

### Measurement of Dielectric Tangent

To the quartz glass fiber-containing films and other glass cloth-containing films of Examples 1 to 2 and Comparative Examples 1 to 7, a network analyzer (E5063-2D5, manufactured by Keysight Technologies) and a strip line (manufactured by KEYCOM Corp.) were connected to measure the dielectric tangent tan 61 at the frequency of 1.0 GHz and the dielectric tangent tan 62 at the frequency of 10 GHz, followed by calculating a value of a numerical formula |tan δ1-tan δ2|. Results are shown in Table 2.

### Measurement of Dielectric Constant

To the quartz glass fiber-containing films and other glass cloth-containing films of Examples 1 to 2 and Comparative Examples 1 to 7, a network analyzer (E5063-2D5, manufactured by Keysight Technologies) and a strip line (manufactured by KEYCOM Corp.) were connected to measure the dielectric constant at the frequency of 1.0 GHz. Results are shown in Table 2.

TABLE 2

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | Example 1 | Example 2 | Example 1 | Example 2 | Example 3 | Example 4 | Example 5 | Example 6 | Example 7 |
| \|tan δ1 − | 0.009 | 0.005 | 0.015 | 0.014 | 0.016 | 0.015 | 0.025 | 0.011 | 0.010 |
| tan δ2\| | | | | | | | | | |
| Dielectric | 3.4 | 3.1 | 4.8 | 4.6 | 5.5 | 5.0 | 3.9 | 3.6 | 3.7 |
| constant | | | | | | | | | |
| at 1 GHz | | | | | | | | | |

### Examples 1, 2

As shown in Table 2, in Examples 1, 2, it was found that excellent values of the dielectric characteristics were obtained when the quartz glass cloth having high purity was used. Therefore, it was shown that the present invention is useful.

### Comparative Examples 1 to 7

On the other hand, in Comparative Examples 1 to 7 where the quartz glass fiber-containing sheet of the present invention was not used, the dielectric characteristics showed results inferior to Examples.

As shown above, when the quartz glass fiber-containing prepreg of the present invention is used, a radiation dose of alpha-ray is very small and impurity elements are very slight such that each of contents of alkali metal ions of Na⁺, Li⁺ and K⁺ is 1 ppm or lower. Therefore, it was clarified that one excellent in semiconductor applications, in particular, in the dielectric characteristics is obtained.

### Examples 3 to 4, Comparative Examples 8 to 14

### Glass Cloth

Glass cloths having a thickness of 0.1 mm were prepared with glasses shown in Table 3 below. The kind and the number of foams are simultaneously described. By the way, the numbers of foams of the glasses of Comparative Examples 8 to 13 were too many to be able to measure only up to 200 foams.

TABLE 3

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | Unit | Example 3 | Example 4 | Example 8 | Example 9 | Example 10 | Example 11 | Example 12 | Example 13 | Example 14 |
| Kind of | | Quartz | Quartz | E-glass | T-glass | C-glass | S-glass | D-glass | Quartz | Quartz |
| Glass | | glass | glass | | | | | | glass | glass |
| Cloth | | | | | | | | | | |
| Number | foams/m² | 4 | 3 | >200 | >200 | >200 | >200 | >200 | >200 | 125 |
| of Foams | | | | | | | | | | |

### Preparation of Film

A slurry of a filler-containing epoxy resin composition made of 10 pts·mass of a cresol novolak type epoxy resin (product name: EPICLON N-695, manufactured by DIC), 5 pts·mass of a phenol novolak resin (product name: PEHNOLITE TD-2090, manufactured by DIC), 0.1 pt·mass of an imidazole-based curing promotor (product name: 2E4MZ, manufactured by SHIKOKU CHEMICALS CORPORATION), 85 pts·mass of spherical silica (product name: SC-2050-SE, manufactured by ADMATECHS) and 50 pts·mass of a MEK solvent was prepared.

Each of glass cloths shown in Table 3 was soaked in the filler-containing epoxy resin composition slurry, followed by drying at 100° C. for 10 minutes to prepare a prepreg, further followed by curing the prepreg at 180° C. for 4 hours, thus a glass cloth-containing film was prepared. By the way, an adhesion amount of the resin was 55 mass % for all.

### Measurement of Dielectric Tangent

By connecting a network analyzer (E5063-2D5, manufactured by Keysight Technologies) and a strip line (manufactured by KEYCOM Corp.), the dielectric tangent tan 61 at the frequency of 1.0 GHz and the dielectric tangent tan 62 at the frequency of 10 GHz were measured, followed by calculating a value of a numerical formula |tan δ1-tan δ2|. Results are shown in Table 4.

### Measurement of Dielectric Constant

By connecting the network analyzer (E5063-2D5, manufactured by Keysight Technologies) and the strip line (manufactured by KEYCOM Corp.), the dielectric constant at the frequency of 1.0 GHz of the film was measured. Results are shown in Table 4.

### Preparation of Substrate

A slurry of a filler-containing epoxy resin composition made of 10 pts·mass of a cresol novolak type epoxy resin (product name: EPICLON N-695, manufactured by DIC), 5 pts·mass of a phenol novolak resin (product name: PEHNOLITE TD-2090, manufactured by DIC), 0.1 pt·mass of an imidazole-based curing promotor (product name: 2E4MZ, manufactured by SHIKOKU CHEMICALS CORPORATION), 85 pts·mass of spherical silica (product name: SC-2050-SE, manufactured by ADMATECHS) and 50 pts·mass of a MEK solvent was prepared.

Each of glass cloths shown in Table 3 was soaked in the filler-containing epoxy resin composition slurry, followed by drying at 100° C. for 10 minutes to prepare a prepreg. 5 sheets of these prepregs were stacked, followed by preparing a laminated substrate under the condition of 180° C., 4 hours, and 4.0 MPa.

### Heat Resistance Test

The laminated substrate prepared above was cut into a size of 100 mm×100 mm. Subsequently, 10 pores were formed with a drill having a drill diameter of 5 mm. Thereafter, electroless copper plating was performed, and after 5 times of reflow steps at 260° C., peel or swell of the plating in the pores were confirmed. Ones having no occurrence of peel were shown with O, and ones having at least one were shown with x. Results are shown in Table 4.

TABLE 4

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | Example 3 | Example 4 | Example 8 | Example 9 | Example 10 | Example 11 | Example 12 | Example 13 | Example 14 |
| \|tan δ1 − | 0.008 | 0.005 | 0.015 | 0.014 | 0.016 | 0.015 | 0.025 | 0.008 | 0.008 |
| tan δ2\| | | | | | | | | | |
| Dielectric | 3.4 | 3.1 | 4.8 | 4.6 | 5.5 | 5.0 | 4.1 | 3.8 | 3.6 |
| constant | | | | | | | | | |
| at 1 GHz | | | | | | | | | |
| Heat | ∘ | ∘ | x | x | x | x | x | x | x |
| resistance | | | | | | | | | |

As shown in Table 4, by using a quartz glass cloth having small number of foams, it was found that the dielectric characteristics are excellent and swell or peel of the plating do not occur. Therefore, it was shown that the present invention is useful.

### Examples 5 to 7, Comparative Examples 15 to 23

### Glass Cloth

With glasses shown in Table 5 below, glass cloths having a thickness of 120 μm were prepared. Furthermore, measurement values of the common bending stiffness in a warp thread direction measured according to a method described in JIS R 3240: 2013 (Testing methods for textile glass products) are also shown.

### Preparation of Prepreg

A varnish of an epoxy resin composition was prepared with 10 pts·mass of a cresol novolak type epoxy resin (product name: EPICLON N-695, manufactured by DIC), 5 pts·mass of a phenol novolak resin (product name: PEHNOLITE TD-2090, manufactured by DIC), 0.1 pt·mass of an imidazole-based curing promotor (product name: 2E4MZ, manufactured by SHIKOKU CHEMICALS CORPORATION), and a MEK solvent. An amount of the MEK solvent was adjusted such that a targeted adhesion amount of the resin is obtained.

Subsequently, each of the glass cloths shown in Table 5 was soaked in the epoxy resin composition varnish, followed by drying at 100° C. for 10 minutes to prepare a glass cloth-containing prepreg.

### Common Bending Stiffness

A measurement was performed according to a method described in JIS R 3240: 2013 (Testing methods for textile glass products), and measured values in a warp thread direction were obtained. Results are shown in Tables 6 and 7.

### Measurement of Dielectric Tangent

Each of the prepregs was cured at 180° C. for 4 hours to obtain a glass cloth-containing film. With the film, a network analyzer (E5063-2D5, manufactured by Keysight Technologies) and a strip line (manufactured by KEYCOM Corp.) were connected, and the dielectric tangent tan δ1 at the frequency of 1.0 GHz and the dielectric tangent tan δ2 at the frequency of 10 GHz were measured, followed by calculating a value of a numerical formula |tan δ1-tan δ2|. Results are shown in Tables 6, 7.

### Measurement of Dielectric Constant

Each of the prepregs was cured at 180° C. for 4 hours to obtain a glass cloth-containing film. With the film, a network analyzer (E5063-2D5, manufactured by Keysight Technologies) and a strip line (manufactured by KEYCOM Corp.) were connected, and the dielectric constant at the frequency of 1.0 GHz was measured. Results are shown in Tables 6, 7.

TABLE 5

| | Unit | Glass Cloth 1 | Glass Cloth 2 | Glass Cloth 3 |
|---|---|---|---|---|
| Kind of | | Quartz glass | E-glass | D-glass |
| glass cloth | | | | |
| Common | N · m² | 48 | 20 | 29 |
| bending | | | | |
| stiffness | | | | |

TABLE 6

| | Unit | Example 5 | Example 6 | Example 7 |
|---|---|---|---|---|
| Glass cloth | | 1 | 1 | 1 |
| type | | | | |
| Resin | % | 35 | 45 | 55 |
| adhesion | | | | |
| amount | | | | |
| Common | N · m² | 780 | 1220 | 1530 |
| bending | | | | |
| stiffness | | | | |
| tan δ1-tan | | 0.005 | 0.005 | 0.005 |
| δ2 | | | | |
| Dielectric | | 3.3 | 3.2 | 3.1 |
| constant at | | | | |
| 1 GHz | | | | |

TABLE 7

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | Unit | Example 15 | Example 16 | Example 17 | Example 18 | Example 19 | Example 20 | Example 21 | Example 22 | Example 23 |
| Glass cloth | | 1 | 2 | 2 | 2 | 2 | 3 | 3 | 3 | 3 |
| kind | | | | | | | | | | |
| Adhesion | % | 15 | 15 | 35 | 55 | 80 | 15 | 35 | 55 | 80 |
| amount of | | | | | | | | | | |
| resin | | | | | | | | | | |
| Common | N · | 420 | 360 | 550 | 1020 | 2730 | 400 | 610 | 1100 | 2900 |
| bending | m² | | | | | | | | | |
| stiffness | | | | | | | | | | |
| tan δ1 − | | 0.005 | 0.011 | 0.013 | 0.015 | 0.016 | 0.016 | 0.018 | 0.025 | 0.026 |
| tan δ2 | | | | | | | | | | |
| Dielectric | | 3.5 | 5.8 | 5.6 | 4.8 | 4.6 | 4.8 | 4.5 | 4.1 | 4.0 |
| constant | | | | | | | | | | |
| at 1 GHz | | | | | | | | | | |

As shown in Tables 6 and 7, the present invention was found to have high stiffness and excellent values of the dielectric characteristics. Therefore, it was shown that the present invention is useful.

By the way, the present invention is not limited to the embodiments. The embodiments are only illustrative, and ones that have substantially the same constitution as the technical ideas described in the range of claims of the present invention and that exhibit the similar action effect are all contained in the technical ranges of the present invention.

What is claimed is:

1. A quartz glass fiber-containing prepreg comprising:
(A) a quartz glass fiber; and
(B) a curable resin composition,
wherein at least one condition of conditions (1) to (3):
(1) a dose of α-ray contained in the (A) quartz glass fiber is 0.005 c/cm²·hour or smaller, and, each of metal ion contents of Na⁺, Li⁺ and K⁺ is 1 ppm or lower;
(2) the (A) quartz glass fiber contains the number of foams of 10 foams/m² or smaller a unit area; and
(3) the quartz glass fiber-containing prepreg has the common bending stiffness in the range of a thickness of 100 to 200 μm measured by a method described in JIS R 3420:2013 of 500 N·m² or larger is satisfied.

2. The quartz glass fiber-containing prepreg according to claim 1, wherein a fiber diameter of the (A) quartz glass fiber is 3 μm or larger and 9 μm or smaller, and a fictive temperature is 1,300° C. to 1500° C.

3. The quartz glass fiber-containing prepreg according to claim 1, wherein the (B) curable resin composition contains at least one kind of curable resin among a thermosetting resin and/or a photosetting resin selected from a silicone resin, a curable polyimide resin, a maleimide resin, an epoxy resin, a cyanate resin, and a (meth)acrylic resin.

4. The quartz glass fiber-containing prepreg according to claim 2, wherein the (B) curable resin composition contains at least one kind of curable resin among a thermosetting resin and/or a photosetting resin selected from a silicone resin, a curable polyimide resin, a maleimide resin, an epoxy resin, a cyanate resin, and a (meth)acrylic resin.

5. The quartz glass fiber-containing prepreg according to claim 1, wherein the (B) curable resin composition further contains an inorganic filler.

6. The quartz glass fiber-containing prepreg according to claim 2, wherein the (B) curable resin composition further contains an inorganic filler.

7. The quartz glass fiber-containing prepreg according to claim 3, wherein the (B) curable resin composition further contains an inorganic filler.

8. The quartz glass fiber-containing prepreg according to claim 4, wherein the (B) curable resin composition further contains an inorganic filler.

9. A quartz glass fiber-containing film, comprising a cured material of one sheet of the quartz glass fiber-containing prepreg according to claim 1.

10. The quartz glass fiber-containing film according to claim 9, wherein an absolute value of a difference between a dielectric tangent at 1.0 GHz and a dielectric tangent at 10 GHz is 0 or larger and 0.01 or smaller.

11. A quartz glass fiber-containing substrate comprising:
a laminate cured material of two or more sheets of the quartz glass fiber-containing prepregs according to claim 1.

12. The quartz glass fiber-containing substrate according to claim 11, wherein an absolute value of a difference between a dielectric tangent at 1.0 GHz and a dielectric tangent at 10 GHz is 0 or larger and 0.01 or smaller.
